(19) United States
(12) Patent Application Publication
(10) Pub. No.: US 2022/0321959 A1
(43) Pub. Date: Oct. 6, 2022

(54) MULTIMEDIA SIGNAL PROCESSING DEVICE AND AUTHORIZATION METHOD

(71) Applicant: Atlanta DTH, Inc., Peachtree Corners, GA (US)

(72) Inventors: Daniel James Woolnough, Colchester (GB); Alexander K. Day, Atlanta, GA (US)

(21) Appl. No.: 17/218,491

(22) Filed: Mar. 31, 2021

(51) Int. Cl. H04N 21/4627; H04N 21/438; H04N 21/443; H04N 21/442

(52) U.S. Cl. CPC H04N 21/4627; H04N 21/438; H04N 21/4431; H04N 21/44227

(57) ABSTRACT

A multimedia signal processing device is used between a multimedia signal source and a down-stream multimedia device. The multimedia signal processing device includes a communication unit, a multimedia decoding unit and a judging unit. The communication unit receives a multimedia signal from the multimedia signal source. The multimedia decoding unit decodes the multimedia signal and receives designated device information from the down-stream multimedia device. The judging unit performs an identification procedure according to a set of data stored in a database and the designated device information of the down-stream multimedia device to obtain a judged result to be stored in the multimedia signal processing device and have the multimedia signal processing device perform an action according to the judged result. A related authorization method involving the steps is performed by the multimedia signal processing device.

### FIELD OF THE INVENTION

The present disclosure relates to a multimedia signal processing device, and particularly to a multimedia signal processing device with a flexible authorization mechanism and a related authorization method.

### BACKGROUND OF THE INVENTION

High-bandwidth Digital Content Protection (HDCP) is a specification developed to protect digital entertainment content across digital interfaces, e.g. DisplayPort (DP), Digital Visual Interface (DVI), High-Definition Multimedia Interface (HDMI), Gigabit Video Interface (GVIF) and Unified Display Interface (UDI). According to the specification, the digital audio and video content will not be transmitted to a device that is not authenticated, thus protecting the content from being illegally copied as it travels across the digital interfaces. Where the connected device is not authenticated, the origination device may choose to reduce the resolution of the video and allow transmission across the non authenticated connection.

With the development of HDCP, it starts to be endorsed by the entertainment industry. In order to enable a multimedia device that plays HDCP-encrypted content, the manufacturer must obtain a license for each multimedia device. For example, the manufacture buys a batch of HDCP chips and uses the HDCP chips in its products, wherein each HDCP chip or batch of chips corresponds to unique keys (Key Selection Vector (KSV)). If one of the products is found to be non-compliant to the HDCP specifications, the corresponding keys or batch of HDCP chips may be revoked via the software revocation mechanism.

Thus, a flexible authorization mechanism for dynamically judging the valid states of the multimedia devices is desired.

### SUMMARY OF THE INVENTION

An aspect of the present disclosure provides a multimedia signal processing device used between a multimedia signal source and a down-stream multimedia device. The multimedia signal processing device includes a communication unit, a multimedia decoding unit and a judging unit. The communication unit, in communication with the multimedia signal source, receives a multimedia signal from the multimedia signal source. The multimedia decoding unit decodes the multimedia signal and receives designated device information from the down-stream multimedia device. The judging unit, in communication with the communication unit and the multimedia decoding unit, performs an identification procedure according to a set of data stored in a database and the designated device information of the down-stream multimedia device to obtain a judged result to be stored in the multimedia signal processing device and have the multimedia signal processing device perform an action according to the judged result.

Another aspect of the present disclosure provides an authorization method performed by a multimedia signal processing device used between a multimedia signal source and a down-stream multimedia device. The authorization method includes steps of: storing reference device information in a database of the multimedia signal processing device; receiving designated device information from the down-stream multimedia device; and performing an identification procedure according to the reference device information stored in the database of the multimedia signal processing device and the designated device information of the down-stream multimedia device to obtain a judged result to be stored in the multimedia signal processing device and have the multimedia signal processing device perform an action according to the judged result.

According to the present disclosure, the multimedia signal processing device and the authorization method can perform a specific action such as altering the output mode or recording the device information of the suspect down-stream multimedia device for further consideration based on a comprehensive judged result. The authorization mechanism can properly judge the valid state of the down-stream multimedia device and increase the operator's confidence of the video display product.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a block diagram illustrating a multimedia signal processing device used between a multimedia signal source and a down-stream multimedia device according to an embodiment of the present disclosure.

FIG. 2 is a block diagram illustrating a multimedia signal processing device used between a multimedia signal source and a down-stream multimedia device according to another embodiment of the present disclosure.

FIG. 3 is a flowchart illustrating an authorization method performed by the multimedia signal processing device of the present disclosure.

FIG. 4 is a flowchart illustrating another authorization method performed by the multimedia signal processing device of the present disclosure.

FIG. 5 is a flowchart illustrating a further authorization method performed by the multimedia signal processing device of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

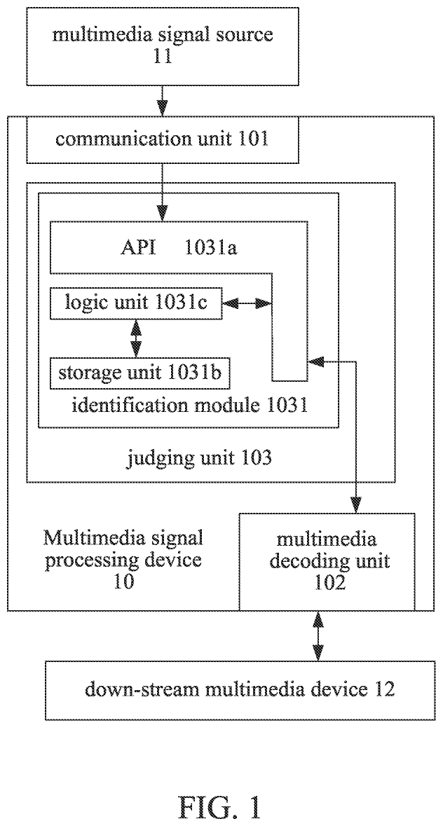

Please refer to FIG. 1, which is a block diagram illustrating a multimedia signal processing device according to an embodiment of the present disclosure. The multimedia signal processing device 10 is used between a multimedia signal source 11 and a down-stream multimedia device 12. In the specification, a set-top box is taken as an example of the multimedia signal processing device 10 for illustration purposes, but any device has the function as described below should be considered equivalent to the multimedia signal processing device 10. Further, the multimedia signal source 11 in the specification may refer to a broadcast/broadband headend, and the down-stream multimedia device 12 in the specification may refer to a display, a TV set, a video game console, a high-definition disc player and/or any intermediate device, e.g. a recorder, a repeater, a switch, a splitter or the like. In the embodiment, the down-stream multimedia device 12 is implemented by a display.

The multimedia signal processing device 10 (e.g. the set-top box) includes two input/output interface connections, i.e. a communication unit 101 and a multimedia decoding unit 102. The communication unit 101 (e.g. a tuner) receives multimedia signals broadcast from the multimedia signal source 11 and representing digital video or audio content through a broadcast medium, e.g. a cable or a wireless medium. The received multimedia signals will be decoded and outputted to the display 12. Thus, the digital video or audio content could be played on the display 12.

Before transmitting the decoded multimedia signals to the display 12, an authorization mechanism is performed to check whether the display 12 is a licensed down-stream multimedia device and allowed to play the digital video or audio content. Therefore, the multimedia signal processing device 10 further includes a judging unit 103 in communication with the communication unit 101 and the multimedia decoding unit 102. The judging unit 103 includes an identification module 1031 for performing an identification procedure. In an embodiment, middleware and/or firmware is executed in the judging unit 103 to perform the identification procedure. The identification module 1031 further includes an application programming interface (API) 1031a, a storage unit 1031b and a logic unit 1031c. The application programming interface 1031a is in communication with the communication unit 101 and the logic unit 1031c. The logic unit 1031c is further in communication with the storage unit 1031b The storage unit 1031b has a database (not shown) for storing a list of authorized/unauthorized device information indicating authorized/unauthorized down-stream multimedia devices, and this device information is called reference device information in the present disclosure. The reference device information could be provided by the multimedia signal source 11, a server or a dedicated service platform (not shown). In an embodiment, the application programming interface 1031a of the identification module 1031 receives the reference device information along with the multimedia signals from the multimedia signal source 11 through the communication unit 101.

In the identification procedure, the multimedia decoding unit 102 obtains the device information (e.g. HDCP keys) of the display 12 through data exchange. The logic unit 1031c receives the reference device information from the storage unit 1031b and the device information of the display 12 from the multimedia decoding unit 102. Then, the logic unit 1031c compares the device information of the display 12 and the reference device information in the authorized list or unauthorized list (e.g. HDCP revocation list) corresponding to the current digital video or audio content to obtain a judged result. In an embodiment, the judged result could be represented by an authorization level determined by the logic unit 1031c. The judged result is stored in the storage unit 1031b when the authorization level conforms to a specific condition. For example, if the authorization level of the display 12 indicates that the current display 12 is a suspicious display, the logic unit 1031c may adjust the output mode of the multimedia decoding unit 102 for outputting the decoded multimedia signals and/or store the related device information of the suspicious display in the storage unit 1031b. The recorded device information will be accessed by authorized personnel through an audio/video output (e.g. DP port, DVI port, HDMI port or the like) of the multimedia signal processing device 10 or reported to the multimedia signal source 11, the server or the dedicated service platform (not shown). Therefore, the multimedia signal source 11, the server or the dedicated service platform can collect more reference device information and provide the new reference device information to other multimedia signal processing devices 10 actively or upon request to update the database. This concept can be applied to build a white list or a revocation list of displays, even various types of down-stream multimedia devices in different applications.

Specifically, the output mode is a normal output mode (e.g. high-definition mode) or an altered output mode. The altered output mode involves, but is not limited to, lower resolution, lower frame-rate, black and white mode, color alteration, disabling high-dynamic-range imaging, audio out of sync, corrupted image, mute mode, no signal output or watermarking.

According to the present disclosure, the multimedia signal processing device 10 used with the multimedia signal source 11 has detection and feedback function. With the expansion of the database storing the reference device information, unauthorized down-stream multimedia device 12 can be detected in a more efficient manner. The authorization mechanism has the flexibility to allow different databases to be used by different operators and therefore affords the operator the control over the devices it allow content to flow to. This is better than revoking keys globally, and the latter usually affects the rights of the legitimate audience and obstructs pushing the digital content protection specification.

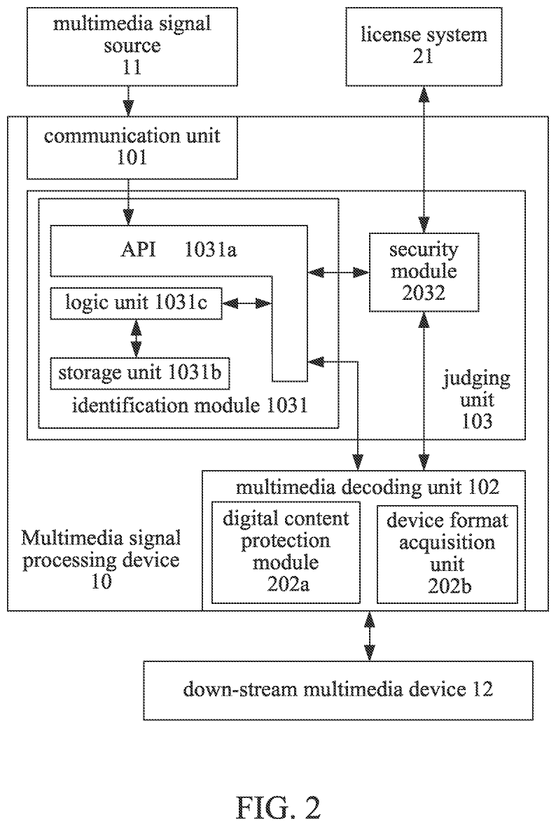

Other judged standards could be introduced to the multimedia signal processing device 10. Please refer to FIG. 2, which is a block diagram illustrating a multimedia signal processing device according to another embodiment of the present disclosure. Compared with the multimedia signal processing device 10 with reference to FIG. 1, the multimedia signal processing device 10 in FIG. 2 further includes a security module 2032 in communication with a digital content protection module 202a (e.g. HDCP register) of the multimedia decoding unit 102 and a license system 21 (e.g. digital right management (DRM) system and/or conditional access system (CAS)). The security module 2032 checks whether the hardware and/or software of the multimedia decoding unit 102 and/or the down-stream multimedia device 12 (e.g. display) in communication with the digital content protection module 202a conforms to the license agreement provided by the license system 21 to obtain a check result. Therefore, the logic unit 1031c could determine the authorization level according to the check result about the license together with the judged result about the device information of the down-stream multimedia device 12 so that the output mode of the multimedia decoding unit 102 or the authorization/unauthorization recordation will be determined based on the related hardware and/or software additionally.

The multimedia decoding unit 102 may further includes a device format acquisition unit 202b to acquire the device format information of the down-stream multimedia device 12 as a part of the device information as described in the above embodiments. For example, the device format information complies with extended display identification data (EDID). Therefore, the device format information could include resolution information, manufacturer information and/or serial number information of the down-stream multimedia device 12, but is not limited to these. The device format information is transmitted from the device format acquisition unit 202b to the identification module 1031 to participate in the identification procedure. The identification module 1031 checks whether there is doubtful format information rendering the down-stream multimedia device 12 suspicious. Therefore, the authorization level is determined with more comprehensive consideration to avoid unfair judgment.

Furthermore, the multimedia signal processing device 10 can detect a connection behavior between the multimedia signal processing device 10 and the down-stream multimedia device 12 through the multimedia decoding unit 102. For example, an old display may require several hot-plug actions in order to be successfully connected to the multimedia signal processing device 10. The multimedia signal processing device 10 may record the required hot-plug actions as the normal condition. If an inconsistent condition is detected such as that the hot-plug actions are omitted, it may be suspected that a principal component of the down-stream multimedia device 12 is replaced or modified. Such modification to the down-stream multimedia device 12 may be impermissible and should be recorded to seek further inspection. Besides, the multimedia signal processing device 10 may detect whether a connection between the multimedia signal processing device 10 and the down-stream multimedia device 12 is valid. For example, if only direct connection between the multimedia set-top box and the display is permitted, any detected intermediate device (e.g. repeater) should be tracked to determine whether to change the authorization level and adjust the output mode of the multimedia signals.

According to the present disclosure, the multimedia signal processing device 10 has a flexible authorization mechanism by considering various factors. The judgment does not rely on assigned keys only, and is adjustable to meet different conditions. Hence, the present disclosure assists in fair use of the digital video or audio content.

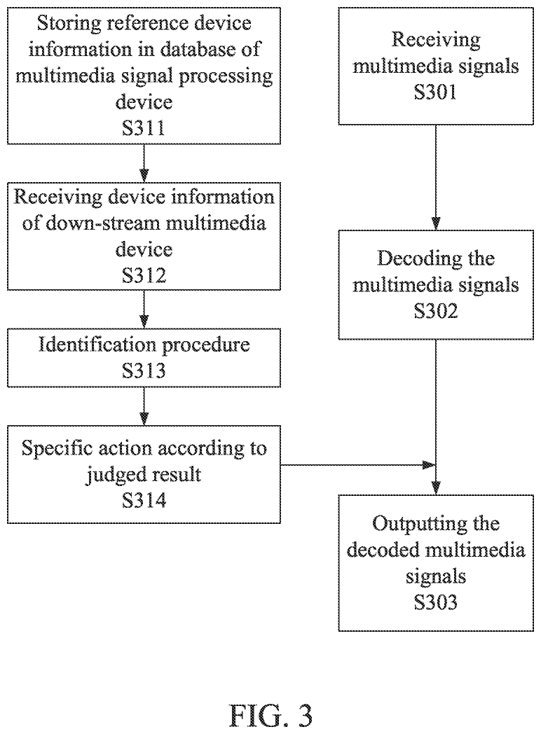

Please refer to FIG. 3, which is a flowchart illustrating an authorization method performed by the multimedia signal processing device of the present disclosure. The multimedia signal processing device (e.g. a set-top box) is configured to receive multimedia signals corresponding to digital video or audio content from the multimedia signal source (e.g. a broadcast/broadband headend) (step S301), decode the multimedia signals to a specific format according to the output terminal of the multimedia signal processing device (step S302), and output the decoded multimedia signals representing the digital video or audio content to the down-stream multimedia device (e.g. a display or other device which has been described in the above embodiments) (step S303). The multimedia signal processing device receives reference device information, e.g. through the communication unit, from the multimedia signal source, the server or the dedicated service platform. For example, the reference device information means a list of authorized/unauthorized device information indicating authorized/unauthorized down-stream multimedia devices. The received reference device information is stored in the database of the multimedia signal processing device (step S311).

Before outputting the decoded multimedia signals to the down-stream multimedia device, the middleware and/or firmware executed in the judging unit of the multimedia signal processing device performs an identification procedure. To perform the identification procedure, the multimedia decoding unit of the multimedia signal processing device obtains the device information (e.g. HDCP keys) of the down-stream multimedia device through data exchange (step S312). Then, the logic unit of the multimedia signal processing device performs the identification procedure by comparing the device information of the down-stream multimedia device and the reference device information previously stored in the database corresponding to the current digital video or audio content to obtain a judged result (step S313). In an embodiment, the judged result could be expressed in a form of an authorization level of the down-stream multimedia device. The judged result is stored in the storage unit of the multimedia signal processing device when the authorization level conforms to a specific condition. The multimedia signal processing device will take a further action according to the judged result (step S314).

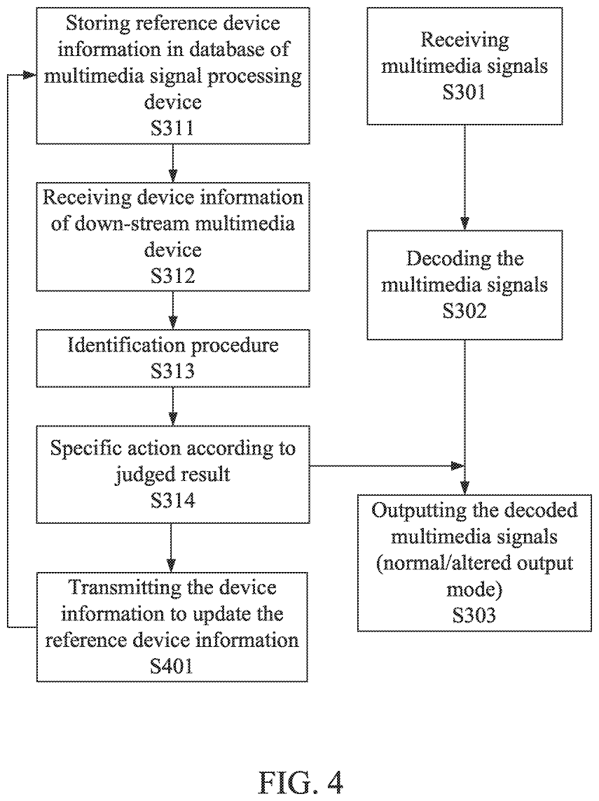

FIG. 4 gives an example of the action performed after the identification procedure according to the judged result (e.g. authorization level). For example, if the judged result indicates that the current down-stream multimedia device is an authorized device, the decoded multimedia signals are transmitted to the down-stream multimedia device in a normal output mode (e.g. high-definition mode) without reducing the video or audio quality. Otherwise, if the judged result indicates that the current down-stream multimedia device is a suspicious device, the decoded multimedia signals may be transmitted to the down-stream multimedia device in an altered output mode, e.g. lower resolution, lower frame-rate, black and white mode, color alteration, disabling high-dynamic-range imaging, audio out of sync, corrupted image, mute mode, no signal output or watermarking to protect the high-quality digital video or audio content from being captured by the suspicious device (Step S303). On the other hand, the device information of the suspicious device could be stored in the storage unit for recordation. The recorded device information will be accessed by authorized personnel through the audio/video output (e.g. DP port, DVI port, HDMI port or the like) of the multimedia signal processing device or reported to the multimedia signal source, the server or the dedicated service platform (not shown). Therefore, the multimedia signal source, the server or the dedicated service platform can collect more reference device information (step S401) and then provide the new reference device information to other multimedia signal processing devices actively or upon request to update the database (step S311). This concept can be applied to build the white list or the revocation list of various types of down-stream multimedia devices in different applications.

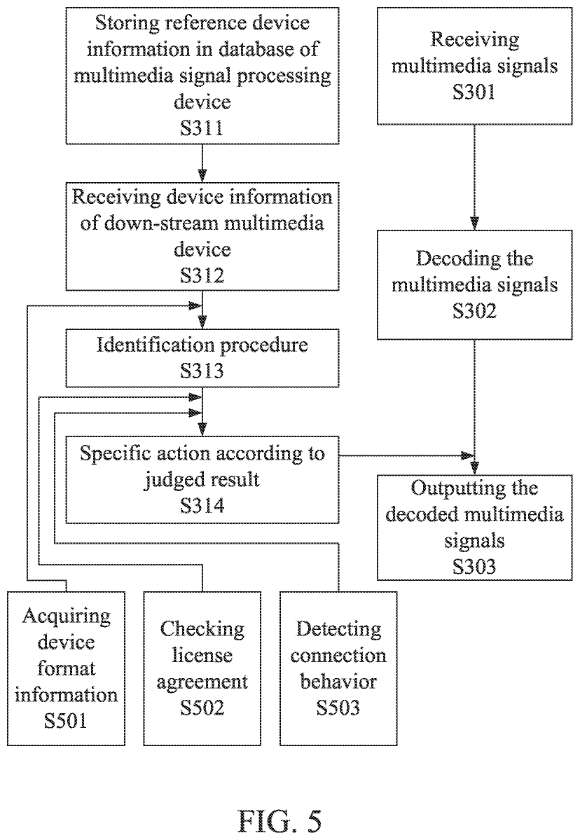

Additional authorization mechanism could be introduced in the authorization method specially adapted for different types of multimedia signals. Please refer to FIG. 5, which is a flowchart illustrating a further authorization method performed by the multimedia signal processing device of the present disclosure. It is to be noted that the steps S501, S502 and S503 in FIG. 5 could be executed solely or in a combined manner to meet different requirements.

In step S501, the device format acquisition unit acquires the device format information of the down-stream multimedia device. For example, the device format information complies with extended display identification data (EDID). Therefore, the device format information could include resolution information, manufacturer information and/or serial number information of the down-stream multimedia device, but is not limited to these. The device format information is transmitted from the device format acquisition unit to the identification module to participate in the identification procedure (step S313). The identification module checks whether there is doubtful format information rendering the down-stream multimedia device suspicious.

In step S502, the security module checks whether the hardware and/or software of the multimedia decoding unit and/or the down-stream multimedia device conforms to the license agreement provided by the license system (e.g. digital right management (DRM) system and/or conditional access system (CAS)) to obtain a check result. Non-compliant hardware or software will lower the authorization level. Therefore, the logic unit could determine the authorization level according to the check result about the license together with the judged result about the device information of the down-stream multimedia device.

In step S503, the multimedia signal processing device detects the connection behavior between the multimedia signal processing device and the down-stream multimedia device. If an inconsistent condition is detected, a principal component of the down-stream multimedia device may be replaced or modified. Such modification to the down-stream multimedia device may be impermissible and should be recorded to seek further inspection. Besides, the multimedia signal processing device may detect whether a connection between the multimedia signal processing device and the display down-stream multimedia device is valid. For example, if only direct connection between the multimedia signal processing device and the down-stream multimedia device is permitted, any detected intermediate device (e.g. repeater) should be tracked to determine whether to change the authorization level and adjust the output mode of the multimedia signals.

Other steps S301˜S314 could be referred to the description with reference to FIG. 3, and similar details are not given herein.

According to the present disclosure, the multimedia signal processing device using the authorization method considers various factors. The authorization method is flexible to allow different databases to be used by different operators. This authorization method can protect the rights of the legitimate audience and assist in pushing the digital content protection specification.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multimedia signal processing device used between a multimedia signal source and a down-stream multimedia device, the multimedia signal processing device comprising:
a communication unit, in communication with the multimedia signal source, for receiving a multimedia signal from the multimedia signal source;
a multimedia decoding unit for decoding the multimedia signal and receiving designated device information from the down-stream multimedia device; and
a judging unit, in communication with the communication unit and the multimedia decoding unit, for performing an identification procedure according to a set of data stored in a database and the designated device information of the down-stream multimedia device to obtain a judged result to be stored in the multimedia signal processing device and have the multimedia signal processing device perform an action according to the judged result.

2. The multimedia signal processing device according to claim 1, wherein the judging unit comprises:
an identification module, in communication with the communication unit and the multimedia decoding unit, wherein middleware and/or firmware executed in the judging unit performs the identification procedure according to the set of data stored in the database and the designated device information of the down-stream multimedia device to determine an authorization level, and determines an output mode of the decoded multimedia signal according to the authorization level so that the multimedia decoding unit outputs the decoded multimedia signal to the down-stream multimedia device based on the determined output mode.

3. The multimedia signal processing device according to claim 2, wherein the identification module comprises:
an application programming interface, in communication with the communication unit, for receiving the multimedia signal and reference device information;
a storage unit having the database for storing the reference device information as the set of data; and
a logic unit, in communication with the application programming interface and the storage unit, for performing the identification procedure according to the reference device information stored in the database and the designated device information of the down-stream multimedia device to generate the authorization level, and determining the output mode of the decoded multimedia signal.

4. The multimedia signal processing device according to claim 3, wherein the application programming interface receives the reference device information from the multimedia signal source or a server.

5. The multimedia signal processing device according to claim 4, wherein the logic unit of the identification module collects additional reference device information from the multimedia signal source or the server to update the database.

6. The multimedia signal processing device according to claim 4, wherein the logic unit of the identification module requests additional reference device information from the multimedia signal source or the server to update the database or transmits the designated device information of the down-stream multimedia device to the multimedia signal source or the server according to the authorization level.

7. The multimedia signal processing device according to claim 6, wherein the logic unit outputs the designated device information to the multimedia signal source or the server through a video output and/or an audio output of the multimedia decoding unit.

8. The multimedia signal processing device according to claim 3, wherein the reference device information is authorized device information indicating authorized down-stream multimedia devices corresponding to the multimedia signal.

9. The multimedia signal processing device according to claim 3, wherein the reference device information is unauthorized device information indicating unauthorized down-stream multimedia devices corresponding to the multimedia signal.

10. The multimedia signal processing device according to claim 3, further comprising:
a security module, in communication with a digital content protection module of the multimedia decoding unit and a license system, for checking whether the multimedia decoding unit or the down-stream multimedia device conforms to a license agreement provided by the license system to obtain a check result,
wherein the logic unit generates the authorization level according to the judged result and the check result.

11. The multimedia signal processing device according to claim 10, wherein the digital content protection module uses high-bandwidth digital content protection (HDCP) specifications.

12. The multimedia signal processing device according to claim 3, wherein the multimedia decoding unit detects a connection behavior between the down-stream multimedia device and the multimedia signal processing device, and the logic unit generates the authorization level according to the judged result and the detected connection behavior.

13. The multimedia signal processing device according to claim 2, wherein the output mode of the decoded multimedia signal is a normal output mode or an altered output mode, and the altered output mode is lower resolution, lower frame-rate, black and white mode, color alteration, disabling high-dynamic-range imaging, audio out of sync, corrupted image, mute mode, no signal output or watermarking.

14. The multimedia signal processing device according to claim 2, wherein the designated device information comprises device format information of the down-stream multimedia device, and the multimedia decoding unit further comprises a device format acquisition unit for acquiring the device format information from the down-stream multimedia device, wherein the device format information comprises resolution information, manufacturer information and/or serial number information of the down-stream multimedia device, and the device format acquisition unit transmits the device format information to the identification module for the identification procedure.

15. The multimedia signal processing device according to claim 14, wherein the device format information complies with extended display identification data (EDID).

16. An authorization method performed by a multimedia signal processing device used between a multimedia signal source and a down-stream multimedia device, the authorization method comprising steps of:
storing reference device information in a database of the multimedia signal processing device;
receiving designated device information from the down-stream multimedia device; and
performing an identification procedure according to the reference device information stored in the database of the multimedia signal processing device and the designated device information of the down-stream multimedia device to obtain a judged result to be stored in the multimedia signal processing device and have the multimedia signal processing device perform an action according to the judged result.

17. The authorization method according to claim 16, wherein the reference device information is received from the multimedia signal source or a server and stored in the database of the multimedia signal processing device.

18. The authorization method according to claim 17, wherein the multimedia signal processing device requests additional reference device information from the multimedia signal source or the server to update the database or transmits the designated device information of the down-stream multimedia device to the multimedia signal source or the server according to the judged result.

19. The authorization method according to claim 16, wherein the reference device information is one of:
authorized device information indicating authorized down-stream multimedia devices corresponding to the multimedia signal; and
unauthorized device information indicating unauthorized down-stream multimedia devices corresponding to the multimedia signal.

20. The authorization method according to claim 16, wherein the multimedia signal processing device receives a multimedia signal from the multimedia signal source and decodes the multimedia signal, the identification procedure is performed by middleware and/or firmware, and the identification procedure comprises steps of:
determining an authorization level according to the reference device information stored in the database of the multimedia signal processing device and the designated device information of the down-stream multimedia device;
determining an output mode of the decoded multimedia signal according to the authorization level; and
outputting the decoded multimedia signal to the down-stream multimedia device based on the determined output mode.

21. The authorization method according to claim 20, further comprising steps of
checking whether a multimedia decoding unit of the multimedia signal processing device or the down-stream multimedia device conforms to a license agreement provided by a license system to obtain a check result; and
generating the authorization level according to the judged result and the check result.

22. The authorization method according to claim 20, further comprising steps of:
detecting a connection behavior between the down-stream multimedia device and the multimedia signal processing device; and
generating the authorization level according to the judged result and the detected connection behavior.

23. The authorization method according to claim 20, wherein the output mode of the decoded multimedia signal is a normal output mode or an altered output mode, and the altered output mode is lower resolution, lower frame-rate, black and white mode, color alteration, disabling high-dynamic-range imaging, audio out of sync, corrupted image, mute mode, no signal output or watermarking.

24. The authorization method according to claim 16, wherein the designated device information comprises device format information of the down-stream multimedia device, and the authorization method further comprises a step of acquiring the device format information for the identification procedure from the down-stream multimedia device, wherein the device format information comprises resolution information, manufacturer information and/or serial number information of the down-stream multimedia device.
